(19) United States
(12) Patent Application Publication
(10) Pub. No.: US 2021/0304990 A1
(43) Pub. Date: Sep. 30, 2021

(54) SENSOR SWITCH

(71) Applicant: Tien-Ming CHOU, Taichung City (TW)

(72) Inventor: Tien-Ming CHOU, Taichung City (TW)

(21) Appl. No.: 17/086,938

(22) Filed: Nov. 2, 2020

(30) Foreign Application Priority Data
Mar. 27, 2020 (TW) 109110580

(51) Int. Cl. H01H 35/02; H01H 1/16; H01H 9/54; H01H 11/04

(52) U.S. Cl. CPC H01H 35/02; H01H 11/045; H01H 9/54; H01H 1/16

(57) ABSTRACT

A sensor switch includes a ceramic body, first and second conductive units and a conductive member. The ceramic body includes intermediate, bottom and top layer assemblies cooperatively defining a chamber. The intermediate layer assembly has an intermediate layer inner peripheral surface. The first conductive unit has a first conductive layer covering the intermediate layer inner peripheral surface. The second conductive unit has a second conductive layer protruding from the bottom layer top surface and spaced apart from the first conductive layer. The conductive member is rollably disposed in the chamber and is limited by the second conductive layer for forming a current path with the first and second conductive layers.

### CROSS REFERENCE TO RELATED APPLICATION

This application claims priority of Taiwanese Patent Application Number 109110580, filed on Mar. 27, 2020.

### FIELD

The disclosure relates to a switch device, more particularly to a sensor switch.

### BACKGROUND

An existing rolling ball sensor switch is configured to be disposed on a circuit board, and uses a rolling ball therein to sense the angle change and then transmit the sensed result to the circuit board. Thus, the rolling ball sensor switch can be used in security alarm devices, anti-theft devices, toys, etc. However, the existing rolling ball sensor switch has many components that occupy a substantial space so that it is difficult to reduce the size thereof.

### SUMMARY

Therefore, an object of the present disclosure is to provide a sensor switch that can alleviate at least one of the drawbacks of the prior art.

According to this disclosure, a sensor switch comprises a ceramic body, first and second conductive units, and a conductive member.

The ceramic body is made from a plurality of raw ceramic blanks that are sintered after being stacked, and includes an intermediate layer assembly, a bottom layer assembly disposed on a bottom portion of the intermediate layer assembly, and a top layer assembly disposed on a top portion of the intermediate layer assembly and opposite to the bottom layer assembly. The intermediate layer assembly, the bottom layer assembly and the top layer assembly cooperatively define a chamber. The intermediate layer assembly has an intermediate layer inner peripheral surface facing the chamber, and an intermediate layer outer peripheral surface opposite to the intermediate layer inner peripheral surface. The bottom layer assembly has a bottom layer top surface connected to the bottom portion of the intermediate layer assembly and facing the chamber, and a bottom layer outer peripheral surface connected to an outer periphery of the bottom layer top surface.

The first conductive unit is made of metal and includes a first conductive layer disposed on and covering the intermediate layer inner peripheral surface, and at least one first internal circuit connected to the first conductive layer and extending from the first conductive layer to the intermediate layer outer peripheral surface.

The second conductive unit is made of metal and includes a second conductive layer disposed on the bottom layer top surface, and at least one second internal circuit connected to the second conductive layer and extending from the second conductive layer to the bottom layer outer peripheral surface. The second conductive layer has a protruding portion protruding from the bottom layer top surface toward the chamber and spaced apart from the first conductive layer.

The conductive member is rollably disposed in the chamber and is movable between a first closed circuit position and an open circuit position. When the conductive member is in the first closed circuit position, the first conductive layer, the conductive member and the second conductive layer form a current path. When the conductive member is in the open circuit position, the first conductive layer, the conductive member and the second conductive layer do not form a current path. When the ceramic body is placed in a normal and horizontal position, in which the bottom layer assembly, the intermediate layer assembly and the top layer assembly are arranged in a bottom-to-top direction, the conductive member is limited by the protruding portion of the second conductive layer and is positioned at the first closed circuit position.

### BRIEF DESCRIPTION OF THE DRAWINGS

Other features and advantages of the disclosure will become apparent in the following detailed description of the embodiments with reference to the accompanying drawings, of which:

FIG. 1 is a perspective view of a sensor switch according to the first embodiment of the present disclosure;

FIG. 2 is a schematic top view of the first embodiment;

FIG. 3 is a sectional view of the first embodiment taken along line III-III of FIG. 2;

FIG. 4 is a sectional view of the first embodiment taken along line IV-IV of FIG. 2;

FIG. 5 is a sectional view of the first embodiment, illustrating a conductive member in a second closed circuit position;

FIG. 6 is an exploded perspective view of the first embodiment;

FIG. 7 is a sectional view of a sensor switch according to the second embodiment of the present disclosure; and

FIG. 8 is a sectional view of a sensor switch according to the third embodiment of the present disclosure.

### DETAILED DESCRIPTION

Before the present disclosure is described in greater detail with reference to the accompanying embodiments, it should be noted herein that like elements are denoted by the same reference numerals throughout the disclosure.

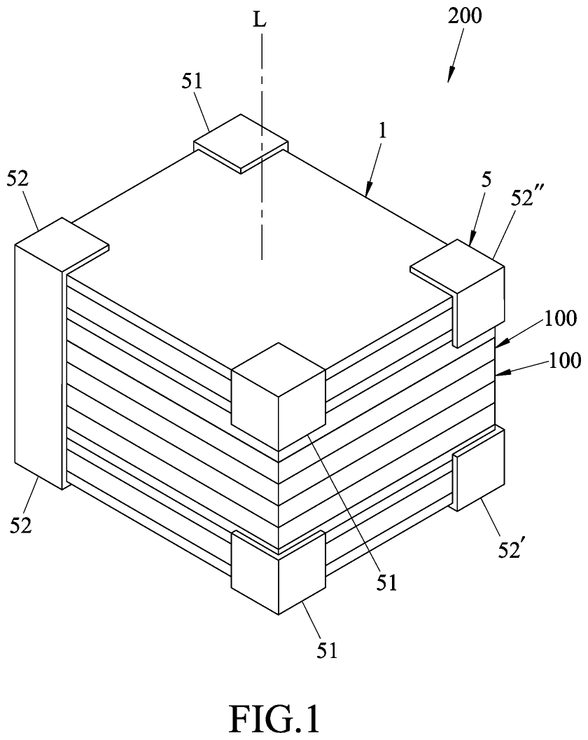

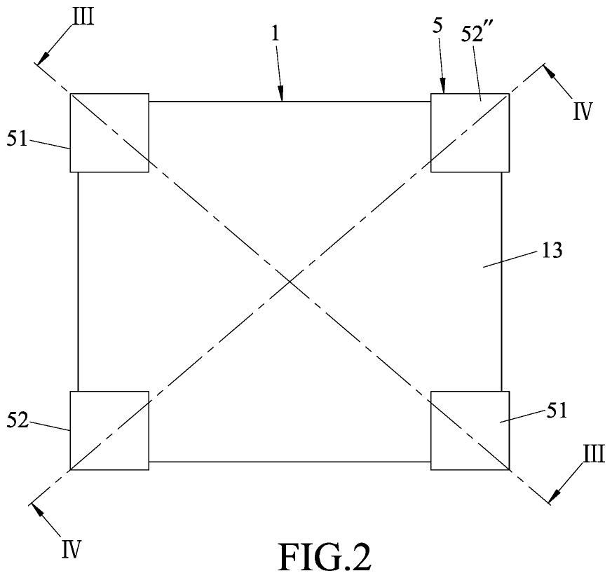

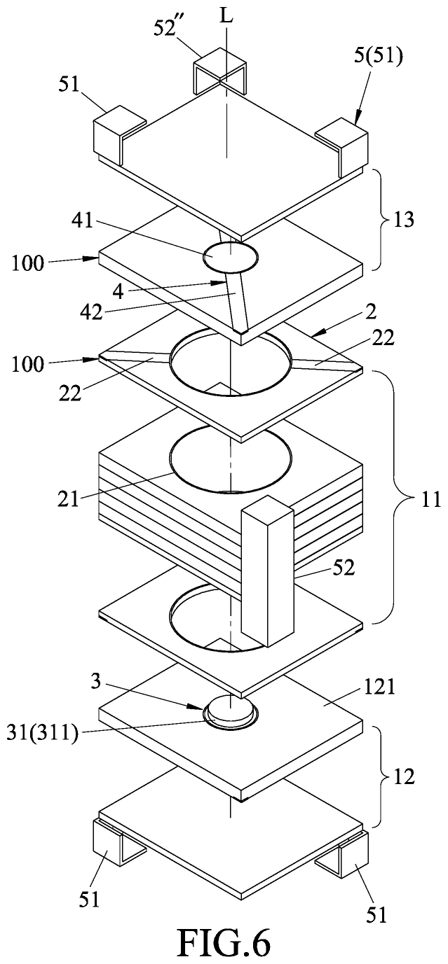

Referring to FIGS. 1 to 6, a sensor switch 200 according to the first embodiment of the present disclosure is suitable for connection with a circuit board (not shown), and includes a ceramic body 1, a first conductive unit 2, a second conductive unit 3, a third conductive unit 4, an external electrode unit 5, and a conductive member 6.

The ceramic body 1 is made from a plurality of raw ceramic blanks 100 that are sintered after being stacked. The ceramic body 1 has a rectangular shape, and includes an intermediate layer assembly 11, a bottom layer assembly 12 disposed on a bottom portion of the intermediate layer assembly 11, and a top layer assembly 13 disposed on a top portion of the intermediate layer assembly 11 and opposite to the bottom layer assembly 12. The bottom layer assembly 12, the intermediate layer assembly 11 and the top layer assembly 13 are normally arranged in a bottom-to-top direction, and cooperatively define a chamber 10. The chamber 24 has an axis (L) parallel to the bottom-to-top direction.

The intermediate layer assembly 11 has an intermediate layer inner peripheral surface 111 facing the chamber 24, and an intermediate layer outer peripheral surface 112 opposite to the intermediate layer inner peripheral surface 111.

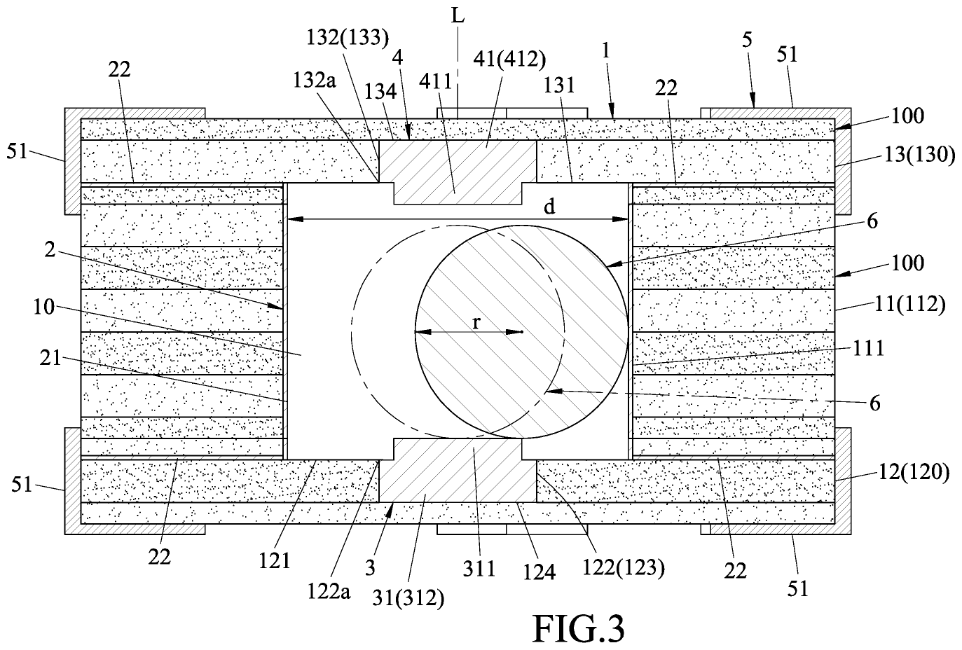

The bottom layer assembly 12 has a bottom layer top surface 121 connected to the bottom portion of the intermediate layer assembly 11 and facing the chamber 10, a bottom groove 122 indented inwardly from the bottom layer top surface 121 and communicating with the chamber 10, and a bottom layer outer peripheral surface 120 connected to an outer periphery of the bottom layer top surface 121. As shown in FIG. 3, the bottom groove 122 is defined by a groove surrounding wall 123 connected to the bottom layer top surface 121, and a groove bottom wall 124 connected to the groove surrounding wall 123 opposite the bottom layer top surface 121. The bottom groove 122 has an open end (122a) communicating with the chamber 10.

The top layer assembly 13 has a top layer bottom surface 131 connected to the top portion of the intermediate layer assembly 11 and facing the chamber 10, a top groove 132 indented inwardly from the top layer bottom surface 131, and a top layer outer peripheral surface 130 connected to an outer periphery of the top layer bottom surface 131. With reference to FIG. 3, the top groove 132 is defined by a groove surrounding wall 133 connected to the top layer bottom surface 131, and a groove bottom wall 134 connected to the groove surrounding wall 133 opposite the top layer bottom surface 131. The top groove 132 has an open end (132a). In this embodiment, the structures of the top layer assembly 13 and the bottom layer assembly 12 are symmetrical to each other.

With reference to FIGS. 3 to 6, the first conductive unit 2 is made of metal, and includes a first conductive layer 21 disposed on and covering the intermediate layer inner peripheral surface 111, and at least one first internal circuit 22. In this embodiment, the first conductive unit 2 includes four first internal circuits 22 connected to the first conductive layer 21 and extending from the first conductive layer 21 to the intermediate layer outer peripheral surface 112. Two of the first internal circuits 22 are located between the bottom portion of the intermediate layer assembly and the bottom layer top surface 121, and are diagonally opposite to each other; while the other two of the first internal circuits 22 are located between the top portion of the intermediate layer assembly 11 and the top layer bottom surface 131, and are diagonally opposite to each other.

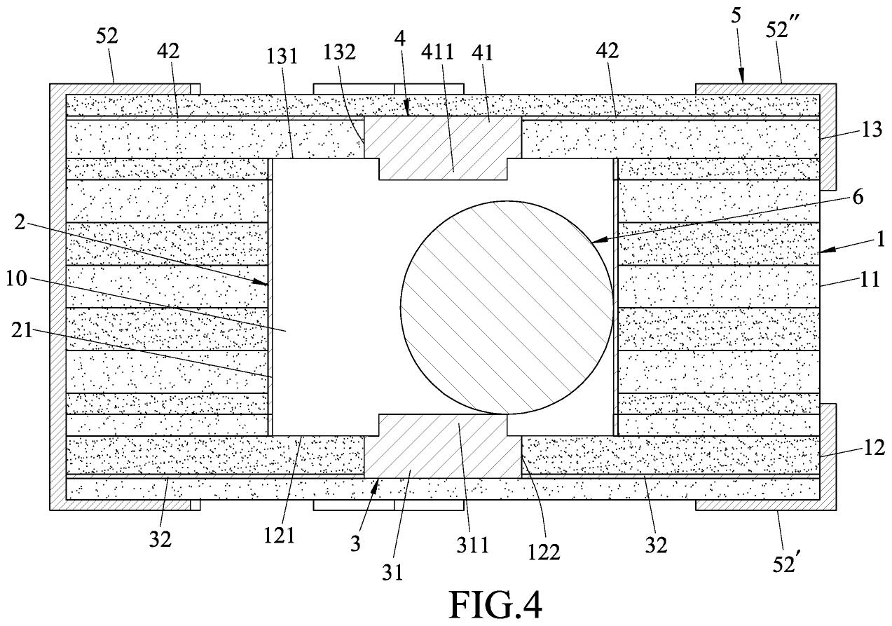

The second conductive unit 3 is made of metal, and includes a second conductive layer 31 disposed in the bottom groove 122, and at least one second internal circuit 32 connected to the second conductive layer 31. The second conductive layer 31 includes a base portion 312 disposed in the bottom groove 122 and having a top end flush with the bottom layer top surface 121, and a protruding portion 311 protruding from the top end of the base portion 312 and extending toward the chamber 10. The protruding portion 311 has a cylindrical shape, and is spaced apart from the first conductive layer 21. In this embodiment, the second conductive unit 3 includes two second internal circuits 32 connected to the second conductive layer 31 at the groove bottom wall 124. The second internal circuits 32 extend from the second conductive layer 31 to the bottom layer outer peripheral surface 120, and are diagonally opposite to each other. Specifically, the second internal circuits 32 are embedded between two raw ceramic blanks 100 that form the bottom layer assembly 12, as shown in FIG. 4.

The third conductive unit 4 is made of metal, and includes a third conductive layer 41 disposed in the top groove 132, and at least one third internal circuit 42 connected to the third conductive layer 41 and extending from the third conductive layer 41 to the top layer outer peripheral surface 130. The third conductive layer 41 includes a base portion 412 disposed in the top groove 132 and having a bottom end flush with the top layer bottom surface 131, and a protruding portion 411 protruding from the top end of the base portion 412 toward the chamber 10. The protruding portion 411 is spaced apart from the first conductive layer 21, and is spaced apart from the protruding portion 311 at a distance greater than a diameter of the conductive member 6. In this embodiment, the third conductive unit 4 has a structure symmetrical to that of the second conductive unit 3. The third conductive unit 4 includes two third internal circuits 42 connected to the third conductive layer 41 at the groove bottom. wall 134. The third internal circuits 42 extend from the third conductive layer 41 to the top layer outer peripheral surface 130, and are diagonally opposite to each other. Specifically, the third internal circuits 42 are embedded between two raw ceramic blanks 100 that form the top layer assembly 13, as shown in FIG. 4. Extending direction of the third internal circuits 42 is similar to that of the second internal circuits 32.

The external electrode unit 5 is disposed on an outer surface of the ceramic body 1, and includes four first external electrodes 51 connected to the first internal circuits 22, and three second external electrodes 52, 52′, 52″. Each of the first external electrodes 51 has a cubic shape. The second external electrode 52 has an elongated cubic shape, and is connected to one of the second external circuits 32 and a corresponding one of the third external circuits 42. The second external electrode 52′ has a cubic shape, and is connected to the other one of second external circuits 32. The second external electrode 52″ also has a cubic shape, and is connected to the other one of third external circuits 42. The first and second external electrodes 51, 52, 52′, 52″ are disposed on corners of the ceramic body 1. Each of the first and second external electrodes 51, 52, 52′, 52″ covers three planes of a corresponding corner of the ceramic body 1. Further, the second external electrode 52 helps determine the direction of the sensor switch 200 from the outside and to connect in series the first and second conductive units 2, 3.

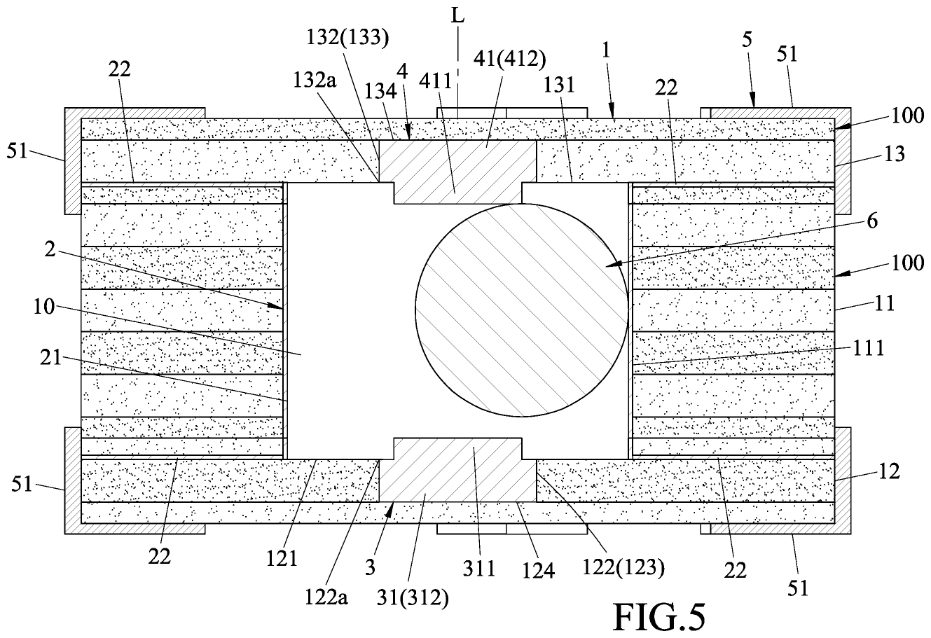

The conductive member 6 is rollably disposed in the chamber 10, and is movable between a first closed circuit position, as shown in solid line in FIG. 3, a second closed circuit position symmetrical to the first closed circuit position in a top-bottom direction, as shown in FIG. 5, and an open circuit position, as shown in imaginary line in FIG. 3. When the conductive member 6 is in the first closed circuit position, the first conductive layer 21, the conductive member 6 and the second conductive layer 31 form a current path. When the conductive member 6 is in the second closed circuit position, the first conductive layer 21, the conductive member 6 and the third conductive layer 41 forma current path. When the conductive member 6 is in the open circuit position, the first conductive layer 21, the conductive member 6 and the second conductive layer 31 do not form a current path; or, the first conductive layer 21, the conductive member 6 and the third conductive layer 41 do not form a current path. Further, when the ceramic body 1 is placed in a normal and horizontal position, in which the bottom layer assembly 12, the intermediate layer assembly 11 and the top layer assembly 13 are arranged in the bottom-to-top direction, the conductive member 6 is limited by the protruding portion 311 of the second conductive layer 31 and is positioned at the first closed circuit position; and, when the ceramic body 1 is turned upside down and is placed horizontally, the conductive member 6 is limited by the protruding portion 411 of the third conductive layer 41 and is positioned at the second closed circuit position.

In this embodiment, the conductive member 6 has a spherical shape and a radius of r, while the chamber 10 has a cylindrical shape. Further, the conductive member 6 has a maximum rolling distance of d in the chamber 10 perpendicular to the axis (L), and 3r<d<4r. In other implementations, the conductive member 6 may be cylindrical, while the chamber 10 maybe rectangular, but are not limited thereto.

To use the sensor switch 200, the sensor switch 200 is first soldered to a circuit board (not shown) using the first and second external electrodes 51, 52, 52′, 52″. Through the disposition of the first and second external electrodes 51, 52, 52′, 52″, the sensor switch 200 can be soldered to the circuit board in different directions according to the requirements of a user or a manufacturer.

In use, when the ceramic body 1 is placed in the normal and horizontal position, the conductive member 6 is limited by the protruding portion 311 of the second conductive layer 31 to simultaneously contact the first and second conductive layers 21, 31 and form a current path. At this time, the conductive member 6 is located in the first closed circuit position (see the solid line in FIG. 3). When the ceramic body 1 is tilted or vibrated, the conductive member 6 breaks away from the limitation of the second conductive layer 31, and is not in contact with at least two of the first conductive layer 21, the second conductive layer 31 and the third conductive layer 41 (see the imaginary line in FIG. 3) so as not to form a current path. Through this, a sensing effect is achieved. Since the structure of this embodiment is symmetrical in a top-bottom direction, when the sensor switch 200 is turned upside down, it can similarly achieve the sensing effect.

Additionally, because the the conductive member 6 has a radius of r and a maximum rolling distance of d perpendicular to the axis (L), and 3r<d<4r, this can effectively reduce the overall volume of the sensor switch 200 and simultaneously prevent excessive sensitivity thereof.

In other implementations, the sensor switch 200 may include two or more conductive members 6. For example, two conductive members 6 of smaller radius are together received in the chamber 10. When the ceramic body 1 is placed horizontally, the conductive members 6 are simultaneously limited by the second conductive layer 31, and are located in the first closed circuit position.

It should be noted that this embodiment is made by multilayer ceramics (MLC) technology. A manufacturing process of the sensor switch 200 of this embodiment involves the following steps:

Step 1: preparing a plurality of raw ceramic blanks 100 made from inorganic ceramic materials and forming holes in the raw ceramic blanks 100 by machining;

Step 2: disposing metal materials, such as silver, gold, palladium, copper, nickel, or alloys thereof, on corresponding surfaces of the raw ceramic blanks 100 by applying conductive adhesive to a stencil, a steel plate, or an ink jet, or by alternately using electroplating, chemical plating, or sputtering so as to form the first conductive unit 2, the second conductive unit 3 and the third conductive unit 4;

Step 3: stacking two raw ceramic blanks 100 one above the other to form the bottom layer assembly 12, stacking eight raw ceramic blanks 100 one above the other to form the intermediate layer assembly 11, and stacking two raw ceramic blanks 100 one above the other to form the top layer assembly 13;

Step 4: stacking together the bottom layer assembly 12 and the intermediate layer assembly 11, and then hot pressing them to form an integral body using the method of hot water pressure equalization, and also hot pressing the two raw ceramic blanks 100 of the top layer assembly 13 using the method of hot water pressure equalization to form one body;

Step 5: stacking a metal layer on the bottom layer top surface 121 so that the second conductive layer 31 protrudes from the bottom layer top surface 121, and stacking a metal layer on the top layer bottom surface 131 so that the third conductive layer 41 protrudes from the top layer bottom surface 131;

Step 6: cutting the stacked bottom and intermediate layer assemblies 12, 11 to a desired size, and cutting the top layer assembly 13 to a size similar to that of the stacked bottom and intermediate layer assemblies 12, 11;

Step 7: raising the ambient temperature to between 400° C. and 600° C. at a slow heating rate to heat the raw ceramic blanks 100 after being cut and to burn and crack the polymer additives added to the raw ceramic blanks 100 during pulping, then the ambient temperature is raised to between 800° C. and 900° C. to densify the raw ceramic blanks 100 and remove holes, and sintering the raw ceramic blanks 100 to form the stacked bottom and intermediate layer assemblies 12, 11 into one body and the top layer assembly 13 as another body;

Step 8: processing the second conductive layer 31 and the third conductive layer 41 to form the protruding portion 311 of the second conductive layer 31 and the protruding portion 411 of the third conductive layer 41;

Step 9: disposing metal materials, such as gold, alloy, etc., by electroplating, sputtering or coating on corresponding surfaces of the first conductive unit 2, the second conductive unit 3 and the third conductive unit 4;

Step 10: placing the conductive member 6 in the chamber 10 defined by the stacked bottom and intermediate layer assemblies 12, 11, then coating an adhesive material, such as resin, glass, etc., on a junction of the top layer assembly 13 and the intermediate layer assembly 11, and irradiating or baking with UV light to raise the ambient temperature to between 300° C. and 500° C. to cure the adhesive material, thereby adhering integrally the top layer assembly 13 to the intermediate layer assembly 11 to form the ceramic body 1; and

Step 11: disposing metal materials, such as silver, gold, palladium, copper, nickel, or other alloys, by electroplating, sputtering or coating on an outer surface of the ceramic body 1 to form the first and second external electrodes 51, 52, 52′, 52″ of the external electrode unit 5.

Moreover, after step 2, the raw ceramic blanks 100 with the disposed metal materials may first be bonded together to form a block or plural blocks, after which the sintering step is employed to form the block or plural blocks, followed by coating adhesive materials on the blocks. After heat treatment, they are formed into the ceramic body 1. The making of the ceramic body 1 is not limited to the aforesaid steps.

Additionally, the order of the steps of the manufacturing process of the sensor switch 200 may be changed according to the requirements, or may be replaced with other manufacturing method, and is not limited to what is disclosed herein.

Through the aforesaid description, the advantages of this embodiment can be summarized as follows:

1. Through the ceramic body 1 which is made from a plurality of raw ceramic blanks 100 that are sintered after being stacked, and with the first, second and third conductive units 2, 3, 4 being made of metal materials disposed on the raw ceramic blanks 100, the overall volume of the sensor switch 200 can break through the minimum volume limit of the traditional switch made of plastic, can obtain a more streamlined structure and a smaller volume, and can achieve a good sealing effect, so that the first to third conductive units 2, 3, 4 cannot be easily damaged by moisture.

2. By using the relationship of the radius (r) and the maximum rolling distance (d) of the conductive member 6 in the chamber 10 perpendicular to the axis (L) as 3r<d<4r, the overall volume of the sensor switch 200 can be effectively reduced while maintaining moderate sensing sensivity.

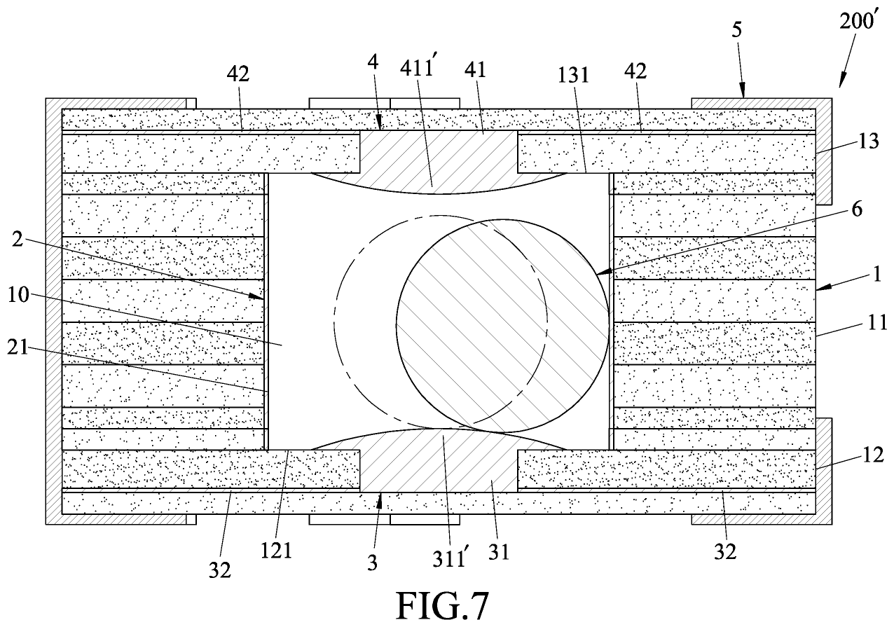

Referring to FIG. 7, the second embodiment of the sensor switch 200′ according to this disclosure is shown to be similar to the first embodiment. The second embodiment differs from the first embodiment in that the protruding portion 311′ of the second conductive unit 3 has a curved shape that curves toward the chamber 10, and the protruding portion 411′ of the third conductive unit 4 also has a curved shape that curves toward the chamber 10.

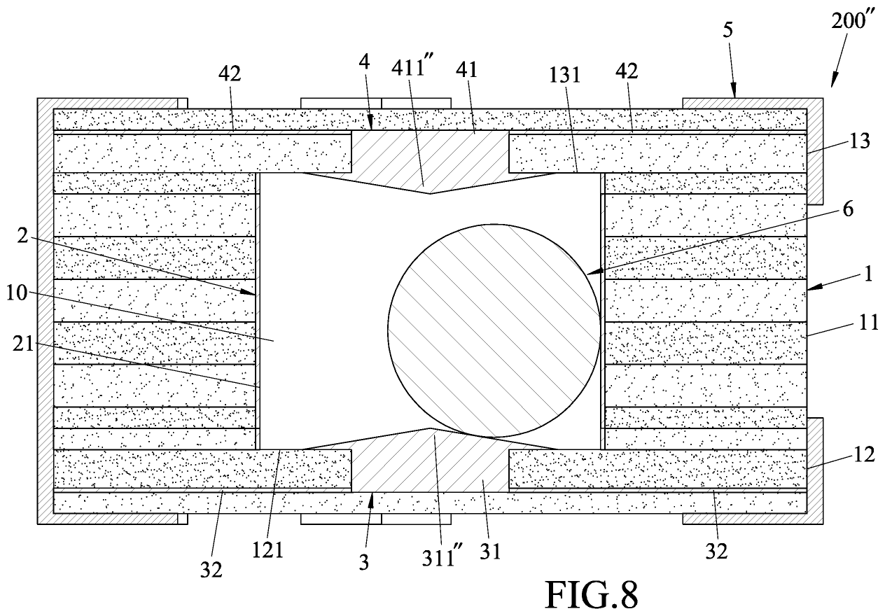

Referring to FIG. 8, the third embodiment of the sensor switch 200″ according to this disclosure is shown to be similar to the first embodiment. However, in this embodiment, the protruding portion 311″, 411″ of each of the second and third conductive units 3, 4 has a conical shape that tapers toward the chamber 10.

In summary, with the ceramic body 1 being made from a plurality of raw ceramic blanks 100 that are sintered after being stacked, and with the first to third conductive units 2, 3, 4 being made of metal materials disposed on the raw ceramic blanks 100, the sensor switch 200, 200′, 200″ of this disclosure can be integrated to effectively reduce components, so that the overall volume thereof can break through the minimum volume limit of the traditional switch made of plastic, thereby obtaining a more streamlined structure and a smaller volume. Moreover, the sensor switch 200, 200′, 200″ can simultaneously achieve a good tight seal effect, so that the first to third conductive units 2, 3, 4 are not easily damaged by moisture. Therefore, the object of this disclosure can indeed be achieved.

In the description above, for the purposes of explanation, numerous specific details have been set forth in order to provide a thorough understanding of the embodiment (s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A sensor switch comprising:
a ceramic body made from a plurality of raw ceramic blanks that are sintered after being stacked, said ceramic body including an intermediate layer assembly, a bottom layer assembly disposed on a bottom portion of said intermediate layer assembly, and a top layer assembly disposed on a top portion of said intermediate layer assembly and opposite to said bottom layer assembly, wherein said intermediate layer assembly, said bottom layer assembly and said top layer assembly cooperatively define a chamber, said intermediate layer assembly having an intermediate layer inner peripheral surface facing said chamber, and an intermediate layer outer peripheral surface opposite to said intermediate layer inner peripheral surface, said bottom layer assembly having a bottom layer top surface connected to said bottom portion of said intermediate layer assembly and facing said chamber, and a bottom layer outer peripheral surface connected to an outer periphery of said bottom layer top surface;
a first conductive unit made of metal and including a first conductive layer disposed on and covering said intermediate layer inner peripheral surface, and at least one first internal circuit connected to said first conductive layer and extending from said first conductive layer to said intermediate layer outer peripheral surface;
a second conductive unit made of metal and including a second conductive layer disposed on said bottom layer top surface, and at least one second internal circuit connected to said second conductive layer and extending from said second conductive layer to said bottom layer outer peripheral surface, said second conductive layer having a protruding portion protruding from said bottom layer top surface toward said chamber and spaced apart from said first conductive layer; and
a conductive member rollably disposed in said chamber and movable between a first closed circuit position and an open circuit position;
when said conductive member is in the first closed circuit position, said first conductive layer, said conductive member and said second conductive layer form a current path;
when said conductive member is in the open circuit position, said first conductive layer, said conductive member and said second conductive layer do not form a current path; and
when said ceramic body is placed in a normal and horizontal position, in which said bottom layer assembly, said intermediate layer assembly and said top layer assembly are arranged in a bottom-to-top direction, said conductive member is limited by said protruding portion of said second conductive layer and is positioned at the first closed circuit position.

2. The sensor switch as claimed in claim 1, wherein said protruding portion of said second conductive layer has a cylindrical shape.

3. The sensor switch as claimed in claim 1, wherein said protruding portion of said second conductive layer has a conical shape that tapers toward said chamber.

4. The sensor switch as claimed in claim 1, wherein said protruding portion of said second conductive layer has a curved shape that curves toward said chamber.

5. The sensor switch as claimed in claim 1, wherein said bottom layer assembly further has a bottom groove indented inwardly from said bottom layer top surface and communicating with said chamber, said second conductive layer being disposed in said bottom groove, said protruding portion of said second conductive layer protruding out of said said bottom groove, said bottom groove being defined by a groove surrounding wall connected to said bottom layer top surface, and a groove bottom wall connected to said groove surrounding wallopposite said bottom layer top surface, said at least one second internal circuit being embedded between said raw ceramic blanks that form said bottom layer assembly and being connected to said second conductive layer at said groove bottom wall, said at least one second internal circuit extending from said second conductive layer to said bottom layer outer peripheral surface.

6. The sensor switch as claimed in claim 5, wherein said at least one first internal circuit is located between said intermediate layer assembly and said bottom layer assembly.

7. The sensor switch as claimed in claim 5, wherein said at least one first internal circuit is located between said intermediate layer assembly and said top layer assembly.

8. The sensor switch as claimed in claim 1, wherein:
said conductive member has a spherical shape and a radius of r;
said chamber has an axis parallel to the bottom-to-top direction; and
said conductive member has a maximum rolling distance of d in said chamber perpendicular to the axis, and 3r<d<4r.

9. The sensor switch as claimed in claim 1, wherein:
said top layer assembly has a top layer bottom surface connected to said top portion of said intermediate layer assembly and facing said chamber, and a top layer outer peripheral surface connected to an outer periphery of said top layer bottom surface;
said sensor switch further comprises a third conductive unit made of metal and including a third conductive layer disposed on said top layer bottom surface, and at least one third internal circuit connected to said third conductive layer and extending from said third conductive layer to said top layer outer peripheral surface, said third conductive layer having a protruding portion that protrudes from said top layer bottom surface toward said chamber, that is spaced apart from said first conductive layer, and that is spaced apart from said protruding portion of said second conductive layer at a distance greater than a diameter of said conductive member;
said conductive member is further movable in said chamber between a second closed circuit position and the open circuit position;
when said conductive member is in the second closed circuit position, said first conductive layer, said conductive member and said third conductive layer form a current path;
when said conductive member is in the open circuit position, said first conductive layer, said conductive member and said third conductive layer do not form a current path; and
when said ceramic body is turned upside down and is placed horizontally, said conductive member is limited by said protruding portion of said third conductive layer and is positioned at the second closed circuit position.

10. The sensor switch as claimed in claim 1, wherein said first and second conductive units are made by disposing metal materials on corresponding surfaces of said raw ceramic blanks by applying conductive adhesive to a stencil, a steel plate, or an ink jet, or by alternately using electroplating, chemical plating, or sputtering.
